(19) United States
(12) Patent Application Publication
(10) Pub. No.: US 2012/0005632 A1
(43) Pub. Date: Jan. 5, 2012

(54) EXECUTE A COMMAND

(76) Inventors: Paul J. Broyles, III, Cypress, TX (US); Christoph J. Graham, Houston, TX (US)

(21) Appl. No.: 12/827,893

(22) Filed: Jun. 30, 2010

(51) Int. Cl. G06F 3/01; G09G 5/00

(52) U.S. Cl. 715/863; 345/156

(57) ABSTRACT

A method for executing a command including detecting a gesture from a user with a sensor, identifying the gesture and a command associated with the gesture, and identifying at least one corresponding device to execute the command on and configuring a device to execute the command on at least one of the corresponding devices.

### BACKGROUND

When managing, controlling, and/or executing a command on one or more devices, a user can physically access and manipulate input buttons of a corresponding device. Additionally, the user can use a remote control to control and execute a command. Using the remote control, the user can select which of the corresponding devices to execute a command on and proceed to enter one or more commands or instructions to be executed.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with a sensor and a communication component according to an embodiment of the invention.

FIG. 2 illustrates a device detecting a gesture and the device communicating with at least one corresponding device according to an embodiment of the invention.

FIG. 3 illustrates a block diagram of a gesture application identifying a gesture and communicating with at least one corresponding device according to an embodiment of the invention.

FIG. 4 illustrates a block diagram of a gesture application identifying a gesture and executing a command according to an embodiment of the invention.

FIG. 5 illustrates a device with an embedded gesture application and a gesture application stored on a removable medium being accessed by the device according to an embodiment of the invention.

FIG. 6 is a flow chart illustrating a method for executing a command according to an embodiment of the invention.

FIG. 7 is a flow chart illustrating a method for executing a command according to another embodiment of the invention.

### DETAILED DESCRIPTION

By detecting a gesture from a user using a sensor, the gesture and a command corresponding to the gesture can accurately be identified. Additionally by identifying at least one corresponding device to execute the identified command on, the identified command can be efficiently and conveniently be executed on one or more of the corresponding devices. As a result, a user friendly experience can be created for the user while the user is controlling and/or managing one or more of the corresponding devices.

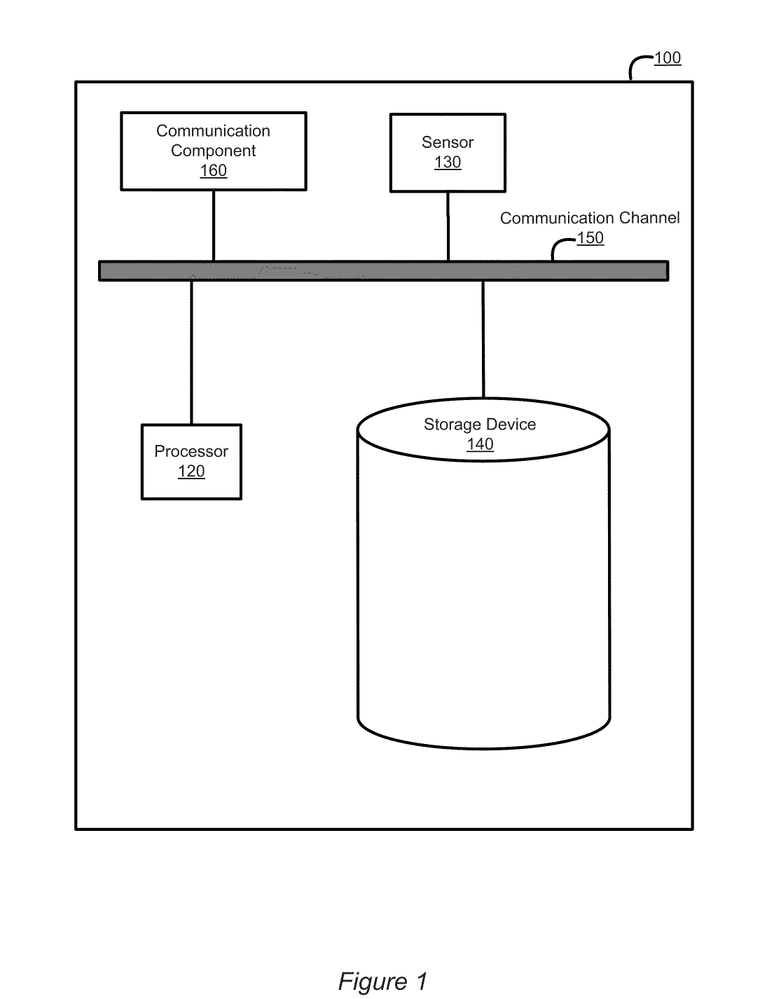

FIG. 1 illustrates a device 100 with a sensor 130 and a communication component 160 according to an embodiment of the invention. In one embodiment, the device 100 is a set-top box configured to couple to one or more corresponding devices around the device 100. In another embodiment, the device 100 is a desktop, a laptop, a netbook, and/or a server. In other embodiments, the device 100 is any other computing device which can include a sensor 130 and a communication component 160.

As illustrated in FIG. 1, the device 100 includes a processor 120, a sensor 130, a communication component 160, a storage device 140, and a communication channel 150 for the device 100 and/or one or more components of the device 100 to communicate with one another. In one embodiment, the storage device 140 is configured to include a gesture application. In other embodiments, the device 100 includes additional components and/or is coupled to additional components in addition to and/or in lieu of those noted above and illustrated in FIG. 1.

As noted above, the device 100 includes a processor 120. The processor 120 sends data and/or instructions to the components of the device 100, such the sensor 130, the communication component 160, and the gesture application. Additionally, the processor 120 receives data and/or instructions from components of the device 100, such as the sensor 130, the communication component 160, and the gesture application.

The gesture application is an application which can be utilized in conjunction with the processor 120 to control or manage one or more corresponding devices by executing at least one command on one or more of the corresponding devices. For the purposes of this application, a corresponding device is a device, component, and/or computing machine which is coupled to the device 100 and is identifiable by the gesture application to execute a command on. When determining which of the corresponding devices to execute at least one command on, a sensor 130 of the device to detects a gesture from a user. A user includes any person which the sensor 130 detects within proximity of the sensor 130 and who is interacting with the device 100 through one or more gestures.

A gesture can include a visual gesture, a touch gesture, a location based gesture, and/or an audio gesture. In response to detecting a gesture from the user, the processor 120 and/or the gesture application proceed to identify the gesture and identify a command associated with the gesture. The command can be one or more control instructions which the user wishes to execute on at least one of the corresponding devices. Once the gesture and the command associated with the gesture have been identified, the processor 120 and/or the gesture application will proceed to configure the device 100 to execute the command on the device 100 and/or at least one of the corresponding devices.

The gesture application can be firmware which is embedded onto the device 100 and/or the storage device 140. In another embodiment, the gesture application is a software application stored on the device 100 within ROM or on the storage device 140 accessible by the device 100. In other embodiments, the gesture application is stored on a computer readable medium readable and accessible by the device 100 or the storage device 140 from a different location.

Additionally, in one embodiment, the storage device 140 is included in the device 100. In other embodiments, the storage device 140 is not included in the device 100, but is accessible to the device 100 utilizing a network interface included in the device 100. The network interface can be a wired or wireless network interface card. In other embodiments, the storage device 140 can be configured to couple to one or more ports or interfaces on the device 100 wirelessly or through a wired connection.

In a further embodiment, the gesture application is stored and/or accessed through a server coupled through a local area network or a wide area network. The gesture application communicates with devices and/or components coupled to the device 100 physically or wirelessly through a communication bus 150 included in or attached to the device 100. In one embodiment the communication bus 150 is a memory bus. In other embodiments, the communication bus 150 is a data bus.

As noted above, the processor 120 can in conjunction with the gesture application manage or control at least one corresponding device by executing one or more commands on at least one of the corresponding devices coupled to the device 100. At least one of the corresponding devices can couple with the device 100 through a communication component 160 of the device 100. The communication component 160 is a device or component configured to couple and interface one or more of the corresponding devices with the device 100. Additionally, the communication component 160 can couple and interface with at least one of the corresponding devices through a physical or wireless connection.

When coupling to a corresponding device, the processor 120 and/or the gesture application send instructions for the communication component 160 to detect at least one of the corresponding devices in an environment around the sensor 130 and/or the device 100. The environment includes a space around the device 100 and the objects within the space. If any of the corresponding devices are detected, the processor 120 and/or the gesture application will configure the communication component 160 to interface or establish a connection with the corresponding device. In another embodiment, the communication component 160 detects one or more of the corresponding devices through a port, a communication channel, and/or a bus of the device 100.

Once the communication component 160 has interfaced and/or established a connection with corresponding devices in the environment, at least one sensor 130 will proceed to detect a gesture from a user. In other embodiments, at least one sensor 130 will detect a gesture from the user before or while the communication component 160 is coupling to at least one of the corresponding devices.

A sensor 130 is a detection device configured to detect, scan for, receive, and/or capture information from the environment around the sensor 130 or the device 100. In one embodiment, the processor 120 and/or the gesture application send instructions for the sensor 130 to initialize and detect a user making one or more gestures in the environment around the sensor 130 or the device 100. In other embodiments, a sensor 130 can automatically detect a user making one or more gestures. In response to detecting a user in the environment, the sensor 130 will notify the processor 120 or the gesture application that a user is detected and the sensor 130 will proceed to scan for a gesture from the user.

As noted above, the gesture can include a visual gesture, a touch gesture, a location based gesture, and/or an audio gesture. When detecting a gesture, the sensor 130 can identify a location of the user and/or detect any audio, motion, and/or touch action from the user. If a position of the user is identified and/or any audio, motion, and/or touch is detected from the user, the gesture application will determine that the user is making a gesture.

In one embodiment, if the user is determined to be making a gesture, the processor 120 and/or the gesture application will instruct the sensor 130 to capture information of the gesture. When capturing information of the gesture, the sensor 130 can capture one or more locations of the user and/or any motion, touch, and/or audio made by the user. Utilizing the captured information, the processor 120 and/or the gesture application will proceed to identify the gesture. In one embodiment, when identifying the gesture, the processor 120 and/or the gesture application compares the captured information from the sensor 130 to information in a database.

The database includes entries for one or more gestures recognized by the processor 120 and/or the gesture application. Additionally, the database can list and/or include the corresponding devices which the device 100 is coupled to. Within the corresponding entries for the recognized gestures includes information corresponding to the recognized gestures. The information can specify details of the recognized gesture, a mode of operation which the recognized gesture can be used in, and/or one or more commands associated with the recognized gesture. Additionally, the information can list one or more of the corresponding devices to for the processor 120 and/or the gesture application to execute a command on or a corresponding device not to execute the command on.

The processor 120 and/or the gesture application will compare the captured information from the sensor 130 to the information in the database and scan for a match. If a match is found, the gesture will be identified as the recognized gesture. Once a recognized gesture has been identified, the processor 120 and/or the gesture application proceed to identify one or more commands to execute. As noted above, a command includes one or more executable instructions which can be executed on one or more corresponding devices. The command can be utilized to enter and/or transition into one more modes of operations for the corresponding devices. Additionally, a command can be utilized to manage a power mode of the corresponding devices. Further, a command can be utilized to manage a functionality of the corresponding devices.

When identifying a command associated with the identified gesture, processor 120 and/or the gesture application scan the corresponding entry for one or more commands. If a command is found to be listed in the corresponding entry, the command will be identified to be executed. The processor 120 and/or the gesture application will then proceed to identify which of the corresponding devices to execute the command on by scanning the corresponding entry for one or more listed corresponding devices. If a corresponding device is found to be listed in the corresponding entry, the listed corresponding device will be identified to have the command executed on it.

In one embodiment, more than one command can be listed in the corresponding entry and more than one command can be executed on at least one of the corresponding devices. If more than one command is listed, the processor 120 and/or the gesture application will proceed to identify which of the corresponding devices to execute each command on. This process can be repeated by the processor 120 and/or the gesture application for each of the listed commands.

The processor 120 and/or the gesture application will then proceed to send one or more instructions for the device 100 to execute the command on the listed corresponding devices. When executing the command, the device 100 can utilize the communication component 160 to send and/or transmit the executable command or instruction to one or more of the corresponding devices identified to have the command executed on. In one embodiment, one or more corresponding devices which are not included in the corresponding entry are additionally identified by the processor 120 and/or the gesture application to not execute the command on.

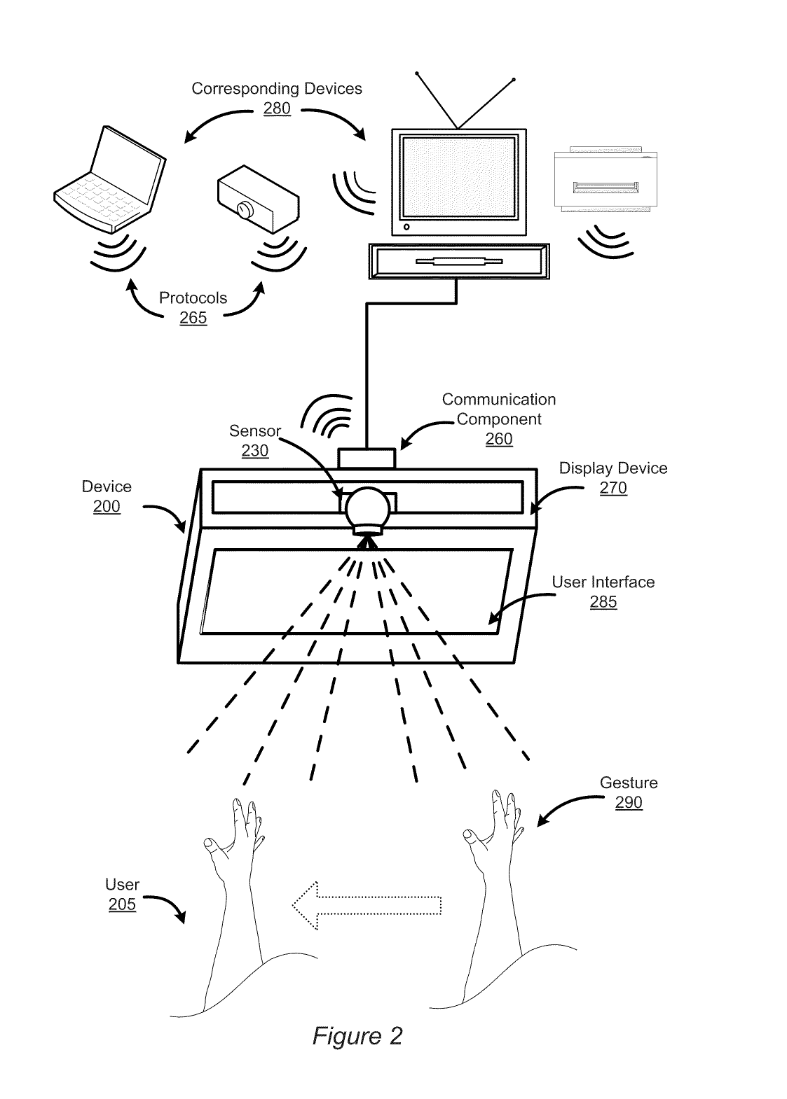

FIG. 2 illustrates a device 200 communicating with at least one corresponding device 280 and the device 200 detecting a gesture 290 from a user 205 according to an embodiment of the invention. As shown in the present embodiment, a corresponding device 280 can be or include a computing machine, a peripheral for the computing machine, a display device, a switch box, a television, a media player, a receiver, and/or a home appliance. The media player can be a radio, a VCR, a DVD player, a blu-ray player, and/or any additional media device. In other embodiments, a corresponding device 280 can include additional devices, components, and/or computing machines configured to interface and couple with the device 200 through a communication component 260 of the device 200.

As illustrated in FIG. 2, the communication component 260 can communicate with at least one of the corresponding devices 280 through a wireless or through a wired connection. For example, the communication component 260 can include a network interface device, a radio frequency device, an infra red device, a wireless radio device, a Bluetooth device, and/or a serial device. In another embodiment, the communication component 260 includes one or more physical ports or interfaces configured to physically engage one or more of the corresponding devices 280. In other embodiments, the communication component 260 can include additional devices configured to couple and interface at least one corresponding device 280 to the device 200.

In one embodiment, when coupling and interfacing with a corresponding device 280, the communication component 260 will attempt to identify one or more protocols 265 utilized by the corresponding device 280. One or more protocols 265 are communication protocols which specify and/or manage how a corresponding device 280 communicates with the communication component 260. For example, one or more of the protocols 265 can include HDLC, MAC, ARP, IP, ICMP, UDP, TCP, GPRS, GSM, WAP, IP, IPv6, ATM, USB, UFIR Infra Red, and/or Bluetooth stack protocol. In other embodiments, additional protocols can be utilized by the communication component 260 and/or at least one of the corresponding devices 280.

As illustrated in FIG. 2, when identifying one or more protocols 265 used by a corresponding device 280, a processor and/or a gesture application of the device 200 can instruct the communication component 260 to send one or more signals utilizing one or more predefined protocols to a corresponding device 280 and scan for a response. Utilizing the received response, the communication component 260 can read and/or analyze the response signal and identify one or more protocols utilized by the corresponding device 280 when communicating with the communication component 260. The communication component 260 can repeat this process for each corresponding device 260 coupled to the device 200. In another embodiment, the communication component 260 can access one or more files on the corresponding devices 280 to identify one or more protocols utilized by the corresponding devices 280.

In response to the communication component 260 coupling to at least one corresponding device 280 and identifying one or more protocols 265 utilized by at least one of the corresponding devices 280, the processor and/or the gesture application of the device can list and store the detected corresponding devices 280 and protocols utilized by the corresponding devices 280. The information of the corresponding devices 280 and the utilized protocols 265 can be stored in a database, a list, and/or a file.

As illustrated in FIG. 2, in one embodiment, the device 200 can be coupled to a display device 270. In another embodiment, the display device 270 can be integrated as part of the device 200. The display device 270 can be an analog or a digital device configured to render, display, and/or project one or more pictures and/or moving videos. The display device 270 can be a television, monitor, and/or a projection device. Additionally, the display device 270 is configured by the device 200 and/or the gesture application to render a user interface 285 for a user to interact with.

The user interface 285 can display one or more of the corresponding devices 280 coupled to the device 200. In one embodiment, the user interface 285 can further be configured to prompt the user to enter one or more gestures 290 for at least one sensor 230 to detect. Once detected, the processor and/or the gesture application can attempt to identify the gesture 290 by searching a database, file, and/or list. Additionally, if the gesture 290 is not found in the database, file, and/or list, the gesture application can create a new recognized gesture with the information of the gesture 290 from the user 205.

In one embodiment, the user interface 285 is additionally configured to prompt the user to associate a detected gesture 290 with one or more commands. In another embodiment, the user interface 285 can be utilized to associate one or more commands with at least one of the corresponding devices 280. When associating one or more of the commands with at least one of the corresponding devices 280; user 200 can identify which of the corresponding devices 280 is to have a command executed on it. Additionally, the user 200 can identify can identify which of the corresponding devices 280 to not have the command executed on it.

As shown in the present embodiment, a sensor 230 can detect and/or capture a view around the sensor 230 for the user 205 and one or more gestures 290 from the user 205. In another embodiment, a sensor 230 can emit one or more signals and detect a response when detecting the user 205 and one or more gestures 290 from the user 205. The sensor 230 can be coupled to one or more locations on or around the device 200. In another embodiment, at least one sensor 230 can be integrated as part of the device 200 or at least one of the sensors 230 can be coupled to or integrated as part of one or more components of the device 200.

In one embodiment, as illustrated in FIG. 2, a sensor 230 can be an image capture device. The image capture device can be or include a 3D depth image capture device. In one embodiment, the 3D depth image capture device can be or include a time of flight device, a stereoscopic device, and/or a light sensor. In another embodiment, the sensor 230 includes at least one from the group consisting of a motion detection device, a proximity sensor, an infrared device, a GPS, a stereo device, a microphone, and/or a touch device. In other embodiments, a sensor 230 can include additional devices and/or components configured to receive and/or scan for information from the environment around the sensor 230 or the device 200.

As illustrated in FIG. 2, in one embodiment, a gesture 290 can include a visual gesture consisting of one or more hand motions. In other embodiments, a gesture 290 can include a touch gesture, an audio gesture, and/or a location based gesture. As shown in the present embodiment, the user 205 makes a hand motion, moving from right to left and the sensor 230 captures a motion of the hand moving from right to left.

In another embodiment, the sensor 230 can detect and/or capture the hand or the user 205 moving forward and/or touching the sensor 230 or the device 200 when detecting motion and/or touch gesture. In other embodiments, the sensor 230 can detect and capture noise, audio, and/or a voice from the user 205 when detecting an audio gesture. In a further embodiment, the sensor 230 can capture a position of the user 205 when detecting a location based gesture. In response to the sensor 230 detecting a gesture 290 from the user 205, the processor and/or the gesture application can proceed to identify the gesture 290 and one or more commands associated with the gesture 290.

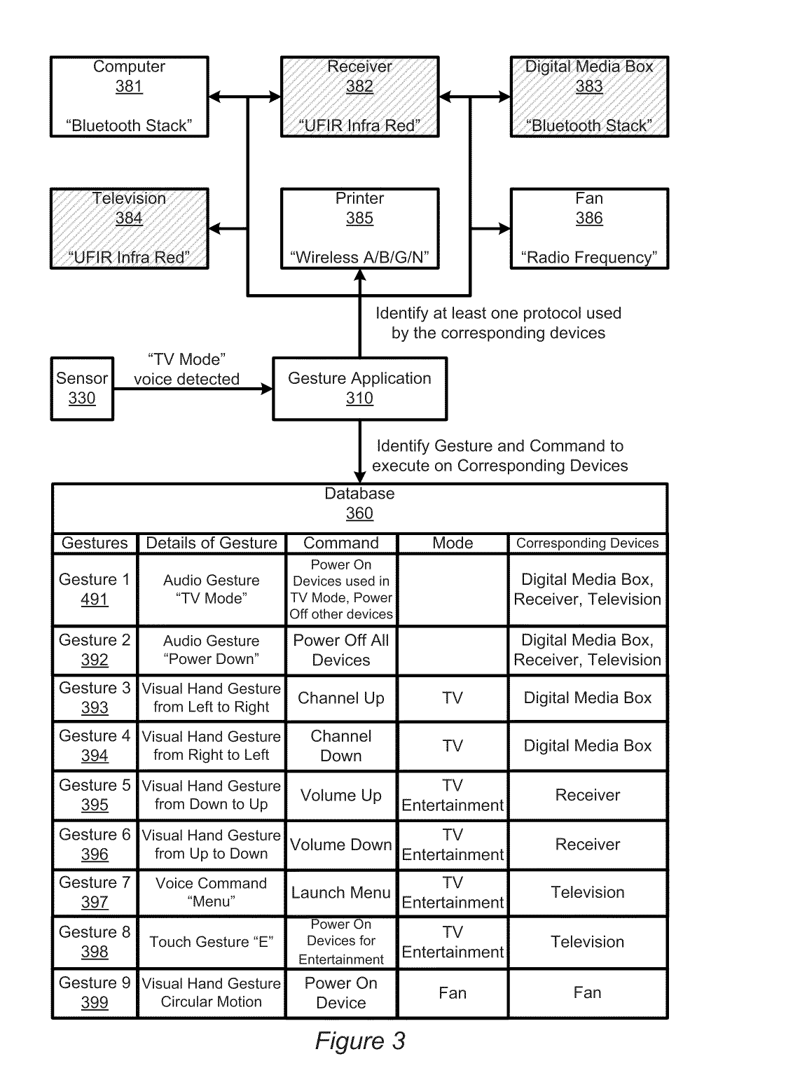

FIG. 3 illustrates a block diagram of a gesture application 310 identifying a gesture and communicating with at least one corresponding device according to an embodiment of the invention. As shown in the present embodiment, a sensor 330 has detected audio from the user and captures the user saying “TV Mode.” In response to receiving the captured information, a gesture application 310 attempts to identify a gesture and a command associated with the gesture to execute on at least one corresponding device.

As shown in the present embodiment, the gesture application 310 accesses a database 360 and attempts to scan one or more entries in the database 360 for a gesture which matches the detected or captured information. The database 360 and the information in the database 360 can be defined and/or updated in response to the user accessing the device or the sensor 330. Additionally, the database 360 be stored and accessed on the device. In another embodiment, the database 360 can be accessed remotely from a server or through another device.

As illustrated in FIG. 3, the database lists one or more recognized gestures and each of the recognized gestures are included in entries of the database. As a result, each recognized gesture has a corresponding entry in the database 360. Further, the entries list additional information corresponding to the recognized gesture. The information can include details of the recognized gesture for the gesture application 310 to reference when identifying a gesture detected by the sensor 330. Additionally, the information can list and/or identify a mode of operation where the recognized gesture can be detected, one or more commands associated with the recognized gesture, and/or one or more corresponding devices to execute a command on. In other embodiments, a file and/or a list can be utilized to store information of a recognized gesture and information corresponding to the recognized gesture.

As illustrated in FIG. 3, a command associated with a recognized gesture can include an instruction to enter into and/or transition between one or more modes of operation. Additionally, a command can include a power on instruction, a power off instruction, a standby instruction, a mode of operation instruction, a volume up instruction, a volume down instruction, a channel up instruction, a channel down instruction, a menu instruction, a guide instruction, a display instruction, and/or an info instruction. In other embodiments, one or more commands can include additional executable instructions or functions in addition to and/or in lieu of those noted above.

As illustrated in the present embodiment, the gesture application 310 scans the “Details of Gesture” section in each of the entries of the database 360 and scans for a gesture which includes audio of “TV Mode.” The gesture application 310 identifies that gesture 1 391 and gesture 2 392 are listed as audio gestures. Additionally, the gesture application 310 determines that gesture 1 391 includes the audio speech “TV Mode.” As a result, the gesture application 310 has found a match and identifies the gesture as a recognized gesture 1 391.

The gesture application 310 proceeds to identify a command associated with the “TV Mode” gesture 1 391 by continuing to scan the corresponding entry for one or more listed commands. As illustrated in FIG. 3, the gesture application 310 identifies that a command to “power on devices used in TV mode” is included in the corresponding entry and is associated with the audio gesture 1 391. Additionally, the gesture application 310 identifies that another command to “power off other devices” is also included in the entry. Further, the gesture application 310 determines that corresponding devices digital media box 383, receiver 382, and television 384 are listed in the corresponding entry associated with the “TV Mode” gesture 1 391.

As a result, the gesture application 310 determines that a power on command will be executed on the digital media box 383, the receiver 382, and the television 384. Additionally, the gesture application 310 determines that a power off command will be executed on the other corresponding devices. As shown in the present embodiment, the gesture application 310 can additionally identify at least one protocol used by the corresponding devices. As shown in the present embodiment, the gesture application 310 has identified that the receiver 382 and television 384 utilize an infrared UFIR protocol and the digital media box 383 uses a Bluetooth stack protocol. In response to identifying the protocols, the gesture application 310 can proceed to transmit and/or execute the “power on” command on the receiver 382 and the television 384 using the UFIR infra red protocol and executes and/or transmits the “power on” command to the digital media box 383 using the Bluetooth stack protocol.

In one embodiment, the gesture application 310 further executes a power off command using the corresponding protocols to the computer 381, printer 385, and the fan 386. In another embodiment, the gesture application 310 can proceed to execute one or more of the commands without identifying the protocols of the corresponding devices. In other embodiment, a processor of the device 300 can be utilized individually or in conjunction with the gesture application 310 to perform any of the functions disclosed above.

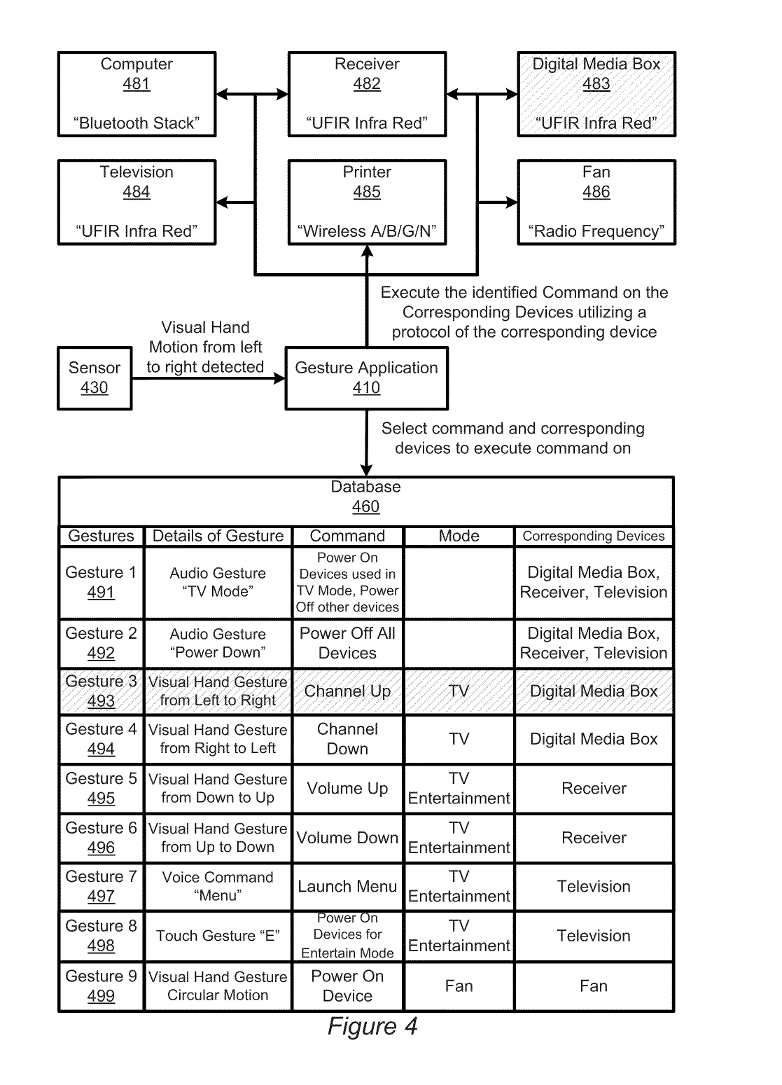

FIG. 4 illustrates a block diagram of a gesture application 410 identifying a gesture and executing a command according to an embodiment of the invention. As illustrated, a sensor 430 has detected and captured the user making a hand motion moving from the left to the right. In response to detecting the gesture and capturing information of the gesture, the gesture application 410 accesses the database 460 to identify the gesture, one or more commands associated with the gesture, a mode of operation which the gesture can be used in, and at least one corresponding device to execute one or more of the commands on.

As shown in the present embodiment, the gesture application 410 scans the “Details of Gesture” section of the entries in the database 460 for a match. As illustrated in FIG. 4, the details of Gesture 3 493 specify for a visual gesture or hand motion from left to right. As a result, the gesture application 410 identifies the visual hand motion from the user as Gesture 3 493. The gesture application 410 continues to scan the corresponding entry and determines that a “Channel Up” command is associated with Gesture 3 493.

In one embodiment, the gesture application 410 additionally determines whether a mode of operation is specified for a command associated with Gesture 3 493 to be executed. As shown in FIG. 4, the corresponding entry of Gesture 3 493 lists for the corresponding devices to be in a “TV Mode.” Because the sensor 430 previously detected the user making an audio gesture to enter into a “TV Mode,” the gesture application 410 determines that a TV Mode has been enabled and proceeds to identify a corresponding device to execute the “Channel Up” command on. The gesture application 410 determines that the digital media box 483 is listed to have the command executed on it. In response, the gesture application 410 proceeds to execute the identified “Channel Up” command on the digital media box 483 using an UFIR Infra red protocol.

In another embodiment, if a mode of operation is not listed, the gesture application 410 will determine that the gesture and the corresponding command can be utilized in any mode of operation. In other embodiments, if the gesture application 410 detects a gesture and identifies the listed mode of operation is different from a current mode of operation, the gesture application 410 can reject the gesture and/or transition the corresponding devices into the listed mode of operation.

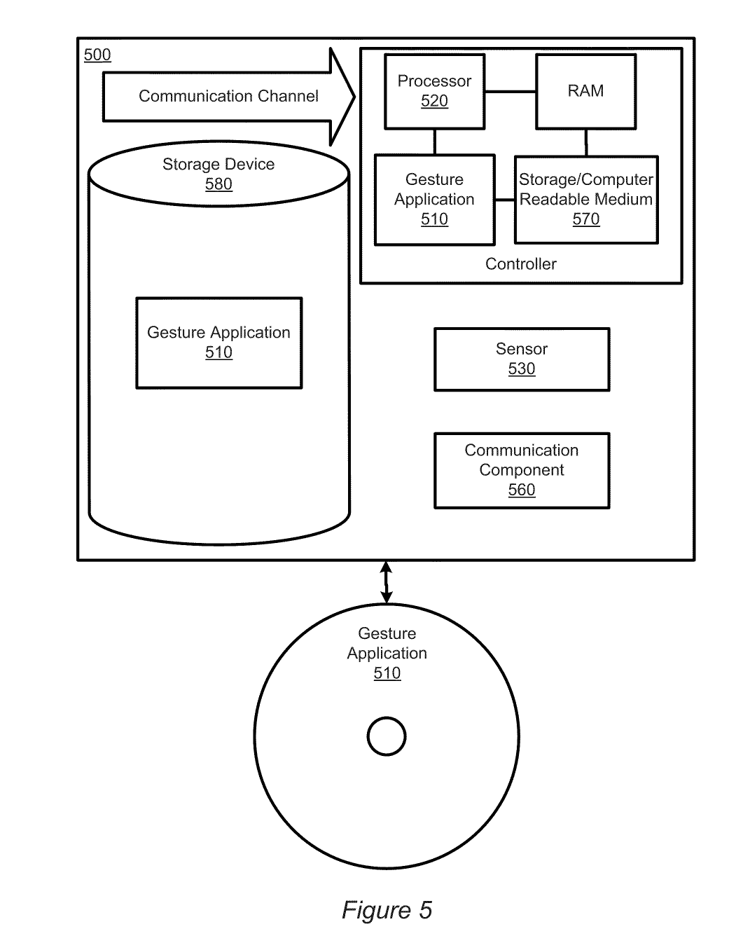

FIG. 5 illustrates a device with an embedded gesture application 510 and a gesture application 510 stored on a removable medium being accessed by the device 500 according to an embodiment of the invention. For the purposes of this description, a removable medium is any tangible apparatus that contains, stores, communicates, or transports the application for use by or in connection with the device 500. As noted above, in one embodiment, the gesture application 510 is firmware that is embedded into one or more components of the device 500 as ROM. In other embodiments, the gesture application 510 is a software application which is stored and accessed from a hard drive, a compact disc, a flash disk, a network drive or any other form of computer readable medium that is coupled to the device 500.

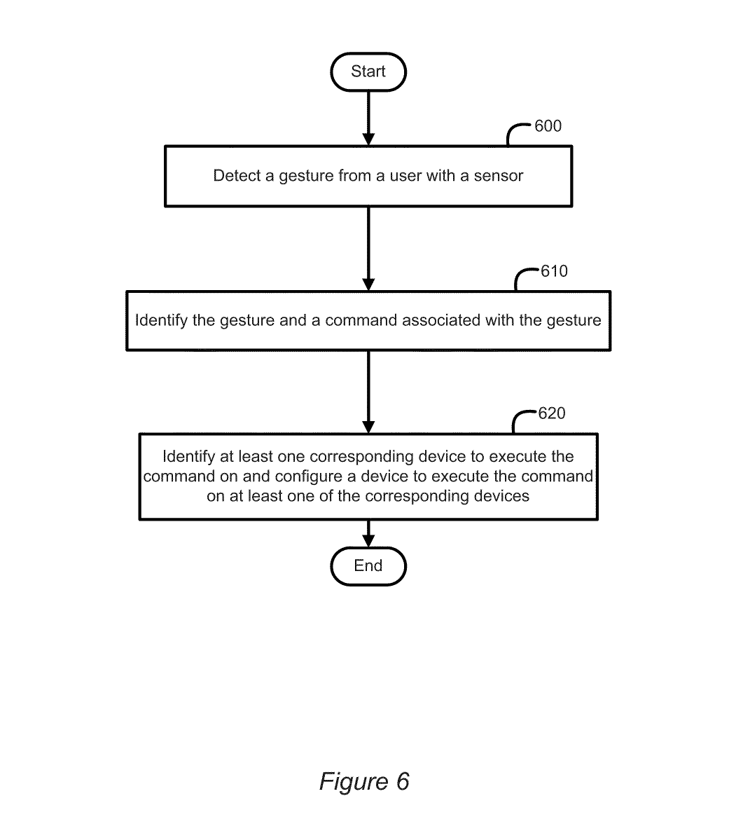

FIG. 6 is a flow chart illustrating a method for executing a command according to an embodiment of the invention. The method of FIG. 6 uses a device with a processor, a sensor, a communication component, a communication channel, a storage device, and a gesture application. In other embodiments, the method of FIG. 6 uses additional components and/or devices in addition to and/or in lieu of those noted above and illustrated in FIGS. 1, 2, 3, 4, and 5.

As noted above, the gesture application is an application which can independently or in conjunction with the processor manage and/or control one or more corresponding devices by executing one or more commands on one or more of the corresponding devices. A corresponding device can include a computing machine, electrical component, media device, home appliance, and/or any additional device which can couple and interface with the device through a communication component of the device. As noted above, the communication component can couple and interface with one or more corresponding devices through a physical or wireless connection.

In one embodiment, in response to coupling to one or more of the corresponding devices, the communication component can proceed to identify one or more protocols used by the corresponding devices. A protocol manages and/or specifies how the corresponding device communicates with the communication component of the device. When identifying a protocol used by a corresponding device, the communication component can access one or more files on the corresponding devices or detect one or more signals broadcasted by the corresponding devices. By detecting one or more of the signals, the gesture application can identify a protocol used by a corresponding device.

Additionally, a sensor of the device can detect a gesture from a user 600. The sensor can be instructed by the processor and/or the gesture application to detect, scan, and/or capture one or more gestures before, while, and/or after the device has coupled to one or more corresponding devices. As noted above, a sensor is detection device configured to detect a user and a gesture from the user in an environment around the sensor and/or the device. A user is anyone which can interact with the sensor and/or the device through one or more gestures.

One or more gestures can include a location based gesture, a visual gesture, an audio gesture, and/or a touch gesture. In one embodiment, when detecting one or more gestures, the sensor is instructed by the processor and/or the gesture application to detect or capture information of the user. The information can include a location of the user, any motion made by the user, any audio from the user, and/or any touch action made by the user.

In response to the sensor detecting and capturing information of a gesture, the gesture application proceeds to identify the gesture and a command associated with the gesture 610. As noted above when identifying the gesture, the processor and/or the gesture application can access a database. The database includes one or more entries. Additionally, each of the entries list a recognized gesture and information corresponding to the recognized gesture. As noted above, the information can specify details of the gesture, a command associated with the gesture, a mode of operation the gesture and/or the command can be used, and/or one or more corresponding devices to execute the command on.

When identifying a gesture, the captured information from the user can be compared to entries in the database. If the processor and/or the gesture application determine that details of a gesture from the database match the captured information, the gesture will be identified as the recognized gesture listed in database. The processor and/or the gesture application will then proceed to scan the corresponding entry of the recognized gesture for one or more commands listed to be associated with the recognized gesture.

As noted above, a command can be listed in the corresponding entry to be associated with a recognized gesture and the command can include an executable instruction which can be transmitted to one or more of the corresponding devices. In one embodiment, the command can be used to enter and/or transition into one or more modes of operation, control a power of the corresponding devices, and/or control a functionality of the corresponding devices. In response to identifying a command associated with the gesture, the processor and/or the gesture application will proceed to identify at least one corresponding device to execute the command on and configure the device to execute the command on at least one of the corresponding devices 620.

When identifying which of the corresponding to devices to execute a listed command on, the corresponding entry of the recognized gesture is scanned for one or more listed corresponding devices. The processor and/or the gesture application will identify each of the corresponding devices listed in the corresponding entry as corresponding devices to have the command executed on it. In one embodiment, if more than one command is listed in the corresponding entry, this process can be repeated for each of the commands. In another embodiment, the processor and/or the gesture application additionally identify one or more corresponding devices not listed in the corresponding entry as corresponding devices to not execute the command on.

The device can then be configured to execute one or more of the commands on the listed corresponding devices. When configuring the device, the processor and/or the gesture application send one or more instructions for the communication component to transmit the command as an instruction to the listed corresponding devices. In one embodiment, the communication component is additionally instructed to utilize a protocol used in the listed corresponding devices when transmitting the command and/or instruction. The method is then complete or the one or more corresponding devices can continue to be managed or controlled in response to a gesture from a user. In other embodiments, the method of FIG. 6 includes additional steps in addition to and/or in lieu of those depicted in FIG. 6.

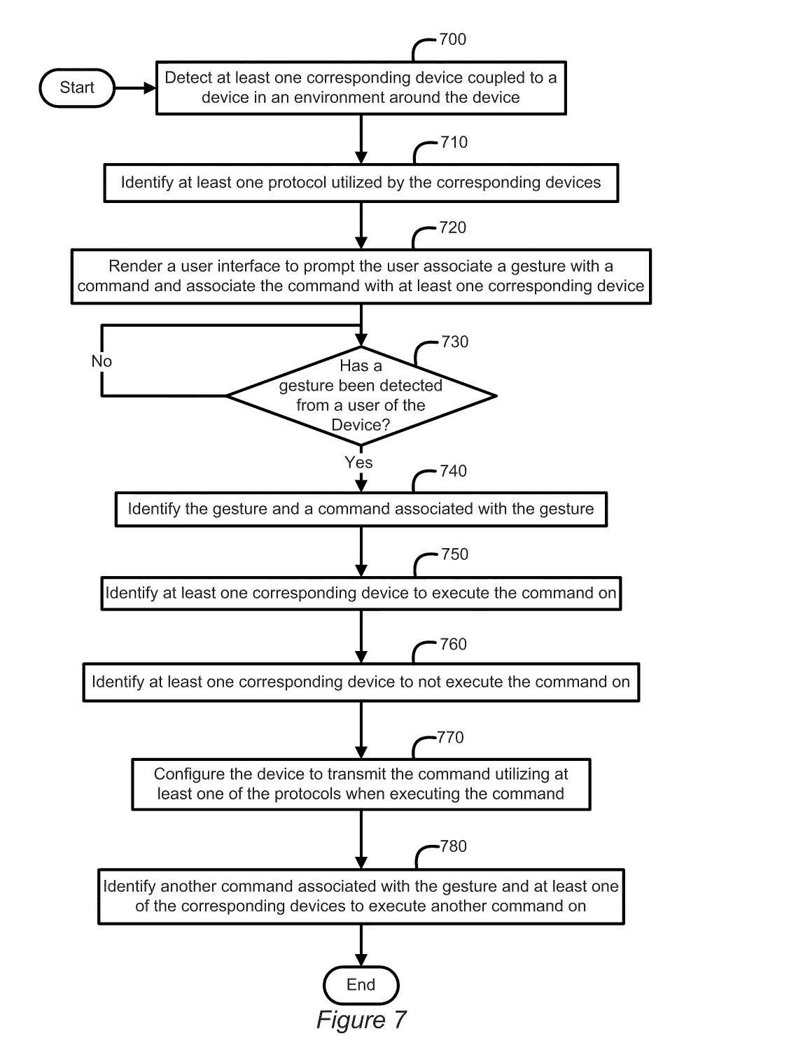

FIG. 7 is a flow chart illustrating a method for executing a command according to another embodiment of the invention. Similar to the method of FIG. 6, the method of FIG. 7 uses a device with a processor, a sensor, a communication component, a communication channel, a storage device, and a gesture application. In other embodiments, the method of FIG. 7 uses additional components and/or devices in addition to and/or in lieu of those noted above and illustrated in FIGS. 1, 2, 3, 4, and 5.

As noted above, a processor and/or a gesture application initially send one or more instructions for a communication component of the device to detect at least one corresponding device coupled to the device in an environment around the device for 700. The communication component can include a network interface device, a radio frequency device, an infra red device, a wireless radio device, a Bluetooth device, and/or a serial device. In another embodiment, the communication component includes one or more physical ports or interfaces configured to physically engage one or more of the corresponding devices. In other embodiments, the communication component can include additional devices configured to couple and communicate with at least one corresponding device through one or more protocols.

Additionally, as noted above, a corresponding device can be or include a computing machine, a peripheral for the computing machine, a display device, a switch box, a television, a media player, a receiver, and/or a home appliance. In other embodiments, a corresponding device can include additional devices, components, and/or computing machines configured to interface and couple with the device through a communication component of the device.

When detecting and coupling to a corresponding device, the communication component can scan a port, a communication channel, and/or a bus for one or more of the corresponding devices. In another embodiment, the communication component can send one or more signals and detect a response. When a response is detected from one or more of the corresponding devices, the communication component can proceed to couple, interface, or establish a connection with one or more of the corresponding devices.

Additionally, the communication component can identify a protocol used by one or more of the corresponding devices by detecting and analyzing the response for a protocol being used 710. In another embodiment, the communication component can access and read one or more files on the corresponding devices to identify a protocol used by the corresponding devices. In other embodiments, additional methods can be used to identify a protocol used by one or more of the devices in addition to and/or in lieu of those noted above.

As noted above, in one embodiment, the device can be coupled to a display device and the display device can render a user interface for the user to interact with. The user can be given the option to define one or more gestures for the processor or gesture application to recognize, identify one or more commands to be associated with a gesture, and/or identify one or more of the corresponding devices for a command to be executed on. In one embodiment, the display device is configured to render a user interface to prompt the user to associate a gesture with a command and associate the command with at least one of the corresponding devices 720.

Once the user has finished defining one or more gestures, a command has been associated, and/or a corresponding device has been listed to execute the command on, a sensor will proceed to detect a gesture from a user and capture information of the gesture 730. As noted above, a sensor can be an image capture device, a motion detection device, a proximity sensor, an infrared device, a GPS, a stereo device, a keyboard, a mouse, a microphone, and/or a touch device. The image capture device can be or include a 3D depth image capture device. In other embodiments, a sensor can include additional devices and/or components configured to detect, receive, scan for, and/or capture information from the environment around the sensor or the device.

In one embodiment, the sensor detects and/or captures information from the user by capturing a location of the user and capturing any audio made by the user, any motion made by the user, and/or any touch action made by the user. The sensor will then share this information for the processor and/or the gesture application to identify the gesture and a command associated with the gesture 740. As noted above, the device can access a database, list, and/or file. Further, the database, list and/or file can include one or more entries which correspond to recognized gestures. Additionally, each of the entries can include information which include details of the gesture, one or more commands associated with the gesture, a mode of operation which the command and/or the gesture can be used in, and/or one or more corresponding devices to execute a command on.

When identifying the gesture, the processor and/or the gesture application compare the captured information from the sensor with information within the entries and scans for an entry which includes matching information. If a match is found, the gesture application will identify the gesture from the user as a recognized gesture corresponding to the entry. The gesture application will then proceed to identify a command associated with the recognized gesture by continuing to scan the corresponding entry for one or more listed commands.

If a command is found, the gesture application will have identified an associated command and proceed to identify at least one device to execute the command on 750. In one embodiment, the gesture application further determines whether a mode of operation is specified in the corresponding entry for the gesture and/or the command to be utilized in. If a mode of operation is specified, the gesture application will proceed to determine whether one or more of the corresponding devices have previously been configured to enter into a mode of operation.

If one or more of the corresponding devices are determined to be in a mode of operation which matches the listed mode of operation, the processor and/or the gesture application will proceed to identify at least one device to execute the command on 750. In another embodiment, if a current mode of operation for one or more of the corresponding devices does not match the listed corresponding device, the command can be rejected or one or more of the corresponding devices can be instructed to transition to enter into the listed mode of operation.

When identifying at least one corresponding device to execute a command on, the corresponding entry of the recognized device can be scanned for one or more corresponding devices listed to be associated with the command. In one embodiment, at least one corresponding device to not execute the command on can be identified by the processor and/or the gesture application by identifying corresponding devices not included in the corresponding entry as corresponding devices not to execute the command on 760.

Once the processor and/or the gesture application have identified which of the corresponding devices to execute a command on and which of the corresponding devices to not execute the command on, the device can be configured to execute and/or transmit the command. In one embodiment, the communication component is additionally configured by the processor and/or the gesture application to utilize protocols used by the corresponding devices when executing and/or transmitting the command 770.

In another embodiment, if more than one command is listed in the corresponding entry of the recognized gesture, the other command can be identified and at least one of the corresponding devices to execute the other command on can be identified by the processor and/or the gesture application 780. In other embodiments, the method of FIG. 7 includes additional steps in addition to and/or in lieu of those depicted in FIG. 7.

What is claimed is:

1. A method for executing a command comprising:
detecting a gesture from a user with a sensor;
identifying the gesture and a command associated with the gesture; and
identifying at least one corresponding device to execute the command on and configuring a device to execute the command on at least one of the corresponding devices.

2. The method for executing a command of claim 1 further comprising detecting at least one corresponding device coupled to the device.

3. The method for executing a command of claim 2 further comprising identifying at least one protocol utilized by at least one of the corresponding devices.

4. The method for executing a command of claim 3 wherein executing the command on at least one of the corresponding devices includes utilizing at least one of the protocols to transmit the command.

5. The method for executing a command of claim 1 further comprising identifying at least one of the corresponding devices to not execute the command on.

6. The method for executing a command of claim 1 further comprising identifying another command associated with the gesture and at least one of the corresponding devices to execute another command on.

7. The method for executing a command of claim 1 further comprising prompting the user to identify which of the corresponding devices to execute the command on.

8. A device comprising:
a sensor configured to detect a gesture from a user in an environment around the device;
a communication component configured to couple the device to corresponding devices; and
a processor to identify a command associated with the gesture and at least one of the corresponding devices to execute the command on.

9. The device of claim 8 further comprising a display device configured to render a user interface of at least one of the corresponding devices.

10. The device of claim 8 wherein the sensor includes at least one from the group consisting of an image capture device, a 3D depth image capturing device, a touch device, a proximity sensor, an infra red device, a motion detection device, a GPS, a stereo device, a microphone, a mouse, and a keyboard.

11. The device of claim 8 further comprising a database configured to store at least one recognized gesture and information corresponding to at least one of the recognized gesture.

12. The device of claim 8 wherein the gesture application configures the communication component to identify at least one protocol utilized by at least one of the corresponding devices in response to coupling to the corresponding devices.

13. The device of claim 8 wherein the communication component includes at least one from the group consisting of a wireless device, an infrared device, and a physical port.

14. The device of claim 12 wherein a first protocol utilized to execute the command on a first corresponding device is different from a second protocol utilized to execute the command on a second corresponding device.

15. A computer-readable program in a computer-readable medium comprising:
a gesture application configured to utilize a sensor to detect a gesture from a user;
wherein the gesture application is additionally configured to identify a command associated with the gesture and at least one corresponding device which the command can be executed on; and
wherein the gesture application is further configured to instruct a communication component to utilize at least one protocol of the corresponding devices when executing the command.

16. The computer-readable program in a computer-readable medium of claim 15 wherein the gesture application is additionally configured to instruct a display device to render a user interface for the user to interact with.

17. The computer-readable program in a computer-readable medium of claim 16 wherein the user interface prompts the user to associate a gesture with at least one command.

18. The computer-readable program in a computer-readable medium of claim 15 wherein the user interface prompts the user to associate at least one of the commands with at least one of the corresponding devices.

19. The computer-readable program in a computer-readable medium of claim 15 wherein a gesture includes at least one from the group consisting of an audio gesture, a touch gesture, a visual gesture, and a location based gesture.

20. The computer-readable program in a computer-readable medium of claim 15 wherein a command includes at least one from the group consisting of a power on instruction, a power off instruction, a standby instruction, a mode of operation instruction, a volume up instruction, a volume down instruction, a channel up instruction, a channel down instruction, and a menu instruction.
